(19) United States
(12) Patent Application Publication
(10) Pub. No.: US 2004/0172362 A1
(43) Pub. Date: Sep. 2, 2004

(54) Optimised recharging of prepaid accounts

(76) Inventors: Rudiger Hausmann, Penzberg (DE); Michael Horn, Munchen (DE); Peter Moritz, Haar (DE); Frank Perthel, Germering (DE)

Correspondence Address: MORRISON & FOERSTER LLP, 1650 TYSONS BOULEVARD, SUITE 300, MCLEAN, VA, 22102, US

(21) Appl. No.: 10/474,689

(22) PCT Filed: Apr. 3, 2002
(86) PCT No.: PCT/EP02/03658

(30) Foreign Application Priority Data
Apr. 12, 2001 (EP) 01109181.6
Aug. 6, 2001 (EP) 0118998.2

(51) Int. Cl. G06F 17/60

(52) U.S. Cl. 705/41

(57) ABSTRACT

The invention relates to a method for recharging an electronic credit prepaid by a user, particularly for paying for services in a data or telecommunication system. The inventive method comprises the following steps: a) setting a lower account threshold value for the credit; b) signalling if the account falls below the threshold value; and c) triggering a recharging function if the value falls below the threshold value.

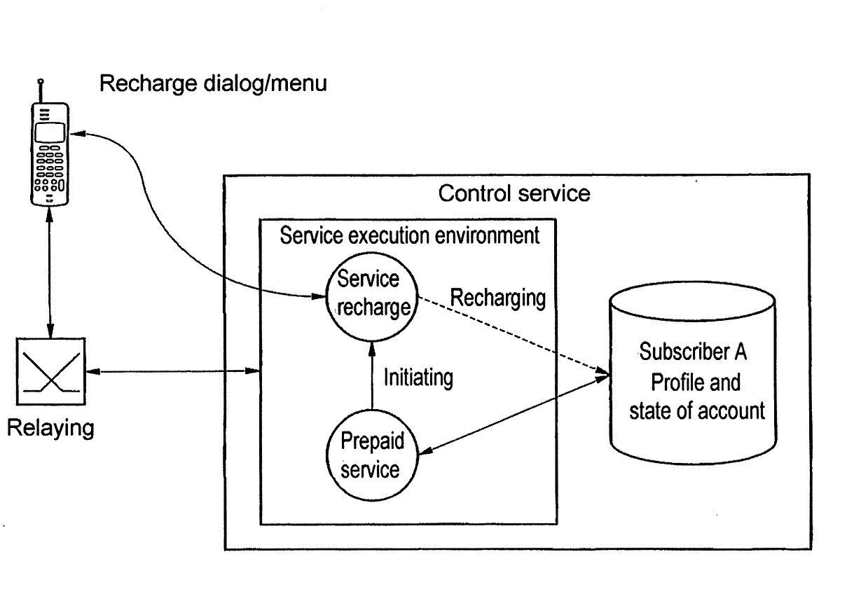

The invention relates to a method in accordance with the pre-characterizing clause of claim 1.

Methods for recharging electronic credit prepaid by a user, particularly for payment of services in a data or telecommunication system, are known from prior art and are usually dealt with by using payments by credit card, transfers, check or cash to an account of a service provider. The use of a prepaid service then usually takes place so that, for example, the mobile telephone of a user is initially registered by a caller line identification (CLI). The user is then called back by means of a callback on his mobile telephone. He then makes the call by dialing, as normal, the required destination subscriber number or, for example, uses one of the speed dialing numbers registered with the service provider. By pressing the # key, the user can receive an announcement of the amount of credit remaining after the call.

Prepaid services of this kind are mainly offered to private customers and in addition to favorable connection charges within Germany also offer considerable savings for international calls depending on the destination country. The particular advantages of these services lie in the accounting being accurate to within seconds, the quarterly detailed individual call records, the simple access to subscriber number registrations (CLI) and being able to dial from any

Despite the aforementioned advantages, service companies offering prepaid services are faced with not inconsiderable problems in this market segment. Thus, particularly in recent years, an attempt has been made to acquire wide categories of buyers as users of this service on the basis of using a mixed calculation from the proceeds from the sale of mobile telephones together with a prepaid usage credit. Particularly in the younger categories of buyers, offers of mobile telephones at an almost zero tariff together with prepaid services (prepaid cards) found wide acceptance.

Recently, it has been realized more and more that, due to the very low average level of prepaid credits, the cost basis of the operation of such an offer is questionable with regard to profitability or even the covering of costs in the short term. It is therefore meanwhile being considered whether to reconfigure the selling prices of mobile telephones so that at least part of the equipment costs are covered. On the other hand, the acceptance of prepaid services should be considerably improved by improved user operability, particularly a simplified recharging of an electronic credit. This should make a credit potential which is higher overall available to the service providers, to enable competitive service portfolios to be offered in the future.

The object of the invention is to provide a method for recharging an electronic prepaid credit that the user can himself adapt in a simple self-explanatory manner to his specific needs.

The object is achieved by a method with the following steps: (a) Setting a lower account threshold for the credit; (b) Signaling the undershooting of the threshold value; and (c) triggering a recharging function if the threshold value is undershot.

The main concept of the method in accordance with the invention is firstly to offer an automatic system that can be set, e.g. as part of the contract for booking the services, and that frees the user from the decision to recharge his electronic credit. In this case, the lower account threshold value, or a number of account thresholds arranged in steps, can be set in such a way that a differentiated recharging of the credit account is also possible independent of the usage conditions.

Advantageous further developments of the method in accordance with the embodiment are given in subclaims 2 to 20.

A method is preferred according to which step (c) is followed by further steps (d) that send a signal to the user and (e) trigger the recharging by the user.

A particular advantage of this method is that the user is then actively linked in to the recharging process and therefore has the possibility of easily performing a topping up of his electronic credit as he wishes. The user thereby has access to set the lower account threshold for the credit. The system behind this novel method is based on the reversal of the function-calls-user sequence of actions to the user-calls-function sequence of actions. This reversal also enables the user at the same time to make extensive interventions with regard to the type and extent of the recharging of his electronic credit.

In a preferred manner, the recharging function is activated when the threshold value is undershot and is superimposed on the service currently being used by the user.

This offers the user the possibility, during a call, of making a timely increase in his electronic credit and thus ensuring that his call is not cut off against his wishes, and possibly his connection blocked due to an inadequate credit level.

As an alternative, it is also possible that the charging function is placed in a waiting state in response to the threshold value being undershot, until the service currently being used by the user is completed. A function of this kind has the advantage that, for example, the current telephone call is not disturbed and instead the user receives a notice on completion to the effect that his minimum credit has been reached and requires recharging.

In a preferred manner, the recharging function can also automatically be repeatedly activated. If, for example, for a user with a prepaid credit of DM 100.00 a relatively high threshold value of DM 20.00 is set, an undershoot of this threshold value would not necessarily cause the connection to be blocked. The user could thus allow time for the recharging of his account because the automatic repeated activation of the recharging function would remind him regularly, and also in increasing short intervals, of the necessity to top up his electronic credit.

If the recharging function remains active even if this is initially broken off or sometimes ignored by the user by triggering a cancel or ignore signal, it is ensured that the user would be given an adequate opportunity to match his prepaid credit to the services he is using, before the connection is blocked.

In an advantageous embodiment, recharging repeatedly within a short time period by means of the method in accordance with the invention is not possible. A recharging operation is then supported only within a specified time period (for example one day). In the event of the mobile telephone being stolen or mislaid the user has adequate time to have his account or mobile telephone blocked before greater financial damage occurs.

A particularly simple recharging of the electronic credit can be achieved in that the recharging function increases the credit by a fixed amount. The recharging by a fixed amount can in this case be triggered from the user end and also the system end. If, for example, the user has contractually agreed with the provider of the services a recharging of his credit by DM 20.00 in each case when the bottom threshold value is reached, he can top up his electronic credit simply by confirming the recharging function (Recharge ?—Yes/No).

A more flexible arrangement of the recharging can be achieved in that the recharging function increases the credit by an amount that can be set by the user. This can be advantageous in so far as a user can have selected a recharging amount on the first use of the booked services, that does not corresponding to the actual utilization of the offer. If, for example, he increasingly makes international calls and at the same time makes more use of voice-mail functions (answer phone functions) and SMS (short message service), an increase in the recharging amount may be necessary.

This can naturally be accompanied by a retrospective change in the lower threshold value of the account at which the user receives notification. Where lower-value services are used, such as telephoning at a local rate, this could be DM 5.00, but where a wider service is more comprehensively utilized, such as Internet access, e-mail, SMS and voice mail it could be substantially higher.

A particularly simple and flexible handling of the recharging function is achieved in that this is controlled by the user by confirming a predetermined payment amount and/or predetermined payment conditions. A predetermined payment amount of this kind can, for example, be selected from a menu with a number of different recharging amounts offered by the recharging function. The user then selects and sets one of the offered payment amounts, e.g. menu driven by display or voice control. The payment conditions can also be preset in a similar manner, with the user then, for example, being able to switch between a debit entry on one or other account or alternatively to a cash payment by means of a prepaid card.

The selection and setting of the payment amount and the actual payment conditions either individually or in combination offer the user a not insubstantial flexibility in the handling of the recharging of his electronic credit for payment of the services used.

In a preferred manner, the recharging function can be modified by the user by entering a payment amount and/or payment conditions. Thus both the payment amount and also the payment conditions can be permanently set for future bookings, e.g. from a giro account. After an account threshold value is undershot followed by a notification to recharge, the user would then only have to confirm the amount and/or payment conditions that have already been set once. A one-off setting of the payment conditions with a re-adapted payment amount in each case if the lower account threshold value is undershot is of course also possible. In this case it is also possible, depending on the set payment amount to automatically change the lower account threshold value using the recharging function, so that for example at recharging amount greater than DM 50.00 it is DM 20.00 but at recharging amount of less than DM 50.00 it is DM 5.00.

An advantageous further development of the method in accordance with the invention is also that the recharging function is performed by means of a voice menu and DTMF (Dual Tone Multiple Frequency) input via a keyboard. A user control of this kind is then particularly useful if the user needs to regularly adapt the recharging to his actual needs. A trouble-free operation of the recharging function, e.g. for the driver of a vehicle, is then ensured in that operation of the recharging function is also possible by means of voice recognition.

It is also relatively easy to control the recharging function by entering an SMS message through the keyboard. This is particularly advantageous where the user is in an environment where a voice message would be disadvantageous, e.g. in fully occupied passenger trains or open-plan offices.

In this case it is also advantageous if the recharging function is controlled on the basis of an IT protocol via a WAP mobile telephone and/or an Internet computer. A picture-controlled recharging function can normally be performed intuitively by a user and is self-explanatory. An Internet page of the service provider that is accessible to the user can in this case offer the same functionalities and possibilities as already described.

The authorization of payments, particularly if the recharging function is controlled via the Internet, is an important subject. The exchange of data should be protected by a cryptographic process, particularly during transmission in the Internet. Suitable programs such as SML (secure socket layer) or PKI (public key infrastructure) are known to the specialist and therefore no further details of their use is given in the following.

It is advantageous if the reference account belongs to the same customer as the prepaid account to be recharged. In this case the customer would suffer no financial loss in the in the event of the mobile telephone being stolen or mislaid, because it would always be ensured that the prepaid account was always recharged from the own reference account.

A further measure of security is achieved if the time period in which the repeated recharging operation can take place is limited. This means that the method is arranged in such a way that the recharging operation is not permitted or supported until after a previously-defined time period has elapsed (for example one day). The advantage of this would be that the rightful owner of the terminal would have sufficient time available to block his account or his mobile telephone.

The method in accordance with the invention is described in more detail in the following with the aid of a drawing. This drawing is a functional diagram that explains the principle sequence of a recharging process of an electronic credit for payment of prepaid services.

Of particular note is a control service designed in the form of an executable software with a service execution environment that includes the services recharge and prepaid. The prepaid service monitors the profile (prepaid credit, booked service scope) stored in a database and uses the account state of a subscriber A, that uses the prepaid services. The control service in this case ensure the smooth interaction between the service execution environment and the database.

If, for example, the current credit of subscriber A drops below a lower threshold value, a recharge service is initiated by the prepaid service. This normally provides for the recharge service to be started in the service execution environment. The control service then takes over the coordination of several service execution environments parts with respect to each other and with respect to the database. The recharge service activates a recharge dialog, or a recharge menu on the display of the mobile telephone, at subscriber A on a mobile telephone used by him, shown in the top left of the illustration. Subscriber A can, for example, select and confirm a recharge amount from a number of preset amounts. At this opportunity, he can possibly as an option reset this preset and selected amount for a future undershoot of the threshold value and at the same time specify his payment conditions.

On conclusion of the user dialog of the recharge service, an exchange of the input data takes place at a relay point. This stores the data of the user in the service execution environment for recharging. The recharge service finally ensures the increase of the electronic credit state and the initiation, e.g. of a corresponding debit entry in a given giro account. If the user also enters a change to the lower account threshold value in the recharge dialog or menu, this is also stored by the recharge service in the database in the profile of subscriber A. In the event of a reducing credit due to the use of services by subscriber A, the prepaid service detects the re-defined lower account threshold and in turn initiates the recharge service if it is undershot. The maximum flexibility of the method for recharging an electronic prepaid credit is therefore available to subscriber A.

Economically-important, future applications of the invention are particularly to be seen in access, on the basis of a prepaid credit, so Internet databases using GPRS or UMTS mobile radio standards. As is known, these modern mobile radio systems enable the transmission of large amount of data at acceptable speed and therefore offer great potential for prepaid applications with user-friendly conditions, such as are realized by the invention. A further economically-important application is the future video-on-demand systems, i.e. in the delivery of films, videoclips or other moving picture files to the holder of a prepaid credit, or also in the analog delivery of music or other audio files on the same basis.

It should be noted at this point that all the steps described above are claimed as essential to the invention, each on their own account and in any combination, particularly the details shown in the illustration. Deviations from this are familiar to the specialist.

1. Method for recharging an electronic prepaid credit of a user, particularly to pay for services in a data or telecommunication system, with the following steps;
a) Setting a lower account threshold value for the credit;
b) Signaling the undershooting of the threshold value;
c) Triggering a recharging function if the threshold value is undershot.

2. Method in accordance with claims 1,
characterized in that,
steps b) and c) include the sub-steps
b1) Transmitting a signal to the user; and
c1) confirming the recharging by the user.

3. Method in according with claim 2,
characterized in that,
after step b1), the sub-steps
b11) Reception of the signal by the user;
b12) Triggering the recharging function by the user and
b13) processing the recharging by the user are carried out.

4. Method in accordance with claim 1,
characterized in that,
the recharging function is activated when the threshold value is undershot and is superimposed on the service currently used by the user.

5. Method in accordance with claim 1,
characterized in that,
the recharging function when the threshold value is undershot is placed in a waiting state until the service currently being used by the user is ended.

6. Method in accordance with one of claims 1 to 5,
characterized in that,
the recharging function is also automatically repeatedly activated.

7. Method in accordance with one of claims 1 to 5, characterized in that,
the recharging function is not activated until after a defined time period.

8. Method in accordance with one of claims 1 to 5, characterized in that,
the recharging function remains active even if this is initially cancelled or sometimes ignored by the user by triggering a cancel or ignore signal.

9. Method in accordance with one of claims 1 to 8, characterized in that,
the recharging function increases the credit by a fixed amount.

10. Method in accordance with one of claims 1 to 8, characterized by
the recharging function increasing the credit by an amount that can be set by the user.

11. Method in accordance with one of the preceding claims, characterized in that,
the recharging function is triggered by the user by confirming a predetermined payment amount and/or predetermined payment condition.

12. Method in accordance with one of the preceding claims, characterized in that, the recharging function can be modified by the user by entering a payment amount and/or payment conditions.

13. Method in accordance with one of the preceding claims, characterized in that,
the recharging function is executed via a keyboard by means of a voice menu and DTMF input.

14. Method in accordance with one of the preceding claims, characterized in that,
the recharging function is implemented by entering a SMS message via a keyboard.

15. Method in accordance with one of the preceding claims, characterized in that,
the recharging function is controlled on the basis of an IP protocol via a WAP mobile telephone and/or and Internet computer/WAP server.

16. Method in accordance with one of the preceding claims, characterized in that,
the exchange of signals and/or data is protected by a cryptographic process.

17. Method in accordance with one of the preceding claims, characterized in that,
the recharging function can be performed by the user only in a time interval from the last recharging of the account.

18. Method in accordance with one of the preceding claims, characterized in that,
the recharging function accesses a reference account of the user.

19. Method in accordance with one of the preceding claims, characterized by
the application to charge for a service, particularly a data provision service, in a GPRS or UMTS mobile radio system based on a prepaid credit.

20. Method in accordance with one of claims 1 to 18, characterized by
the application to charge for the provision of video and/or music and/or voice files in a video-on-demand system or audio-on-demand system based on a prepaid credit.
